(19) United States
(12) Patent Application Publication
(10) Pub. No.: US 2007/0184886 A1
(43) Pub. Date: Aug. 9, 2007

(54) Video based strategic board game

(76) Inventor: Tomas Floden, Stockholm (SE)

Correspondence Address: Tony Magnussen, 5090 Caminito Exquisito, San Diego, CA, 92130, US

(21) Appl. No.: 11/348,666

(22) Filed: Feb. 7, 2006

(51) Int. Cl. G06F 19/00

(52) U.S. Cl. 463/14

(57) ABSTRACT

A video game and related game playing method is described herein. The video game is played on an overall playing field that includes a plurality of rotating square-shaped fields, each having a grid of playing positions. The objective of the game is to be the first to create a pattern of five playing pieces in a row. Players alternate turns, and each turn is initiated by “moving” a playing piece into an unoccupied playing position (i.e., a grid point) on any of the square-shaped fields. The turn is completed by rotating any one of the fields 90 degrees in a clockwise or counterclockwise direction. The dynamic nature of the overall playing field makes the video game interesting, challenging, and difficult to master.

### TECHNICAL FIELD

The present invention relates generally to video games. More particularly, the present invention relates to a video based strategic board game suitable for deployment on mobile devices such as wireless telephones, digital music players, and personal digital assistants.

### BACKGROUND

The prior art is replete with board games and video games in which the objective is to create a specific pattern of consecutive playing pieces. Such games are derivative of the traditional tic-tac-toe game, in which each player attempts to string three Xs or three Os in a row before the other player. Modem and more complex variations of such games include CONNECT FOUR, which features a vertical rack that holds playing pieces as they are inserted one by one by the players, and three-dimensional variations of tic-tac-toe. These types of games, while interesting at first, can become boring and repetitive due to their simplicity and the limited amount of strategic options available to the players. Moreover, it may be challenging to convert some board games into video based games, particularly when such board games have certain physical traits or requirements that are difficult or impossible to render in a video game context. In addition, it may be challenging to convert some board games into small scale video games that are suitable for mobile devices such as cellular telephones, particularly when such board games require complex manipulation of playing pieces or rules that cannot be interpreted or followed using the limited user interfaces of common mobile devices.

Board and video games can be extremely successful if they are is simple to learn, are suitable for players of all skill levels, require strategic thinking, and if game playing does not become repetitive or redundant. These types of successful games include OTHELLO, which features a simple checkerboard layout and playing chips having one white side and one black side. This game has been very popular since its introduction many years ago, and its popularity is due to the factors identified above.

Accordingly, it is desirable to have a simple, easy to learn, yet interesting video based board game that involves a measure of strategic thinking. Furthermore, other desirable features and characteristics of the present invention will become apparent from the subsequent detailed description and the appended claims, taken in conjunction with the accompanying drawings and the foregoing technical field and background.

### BRIEF SUMMARY

A video game apparatus and related game playing method is described herein. The video game is a simple, elegant, and interesting variation of existing board games in which the objective is to string a consecutive number of like colored playing pieces together. The video game generates a graphical representation of movable (rotating) blocks that hold the playing pieces, which results in a dynamic playing field that continually changes during game play.

The above and other aspects of the invention may be carried out in one form by a method of operating a video game having an overall playing field rendering having a grid of playing positions, where the overall playing field rendering includes a plurality of polygonal fields, each having a plurality of playing positions. The video game method involves: (a) receiving selection instructions indicative of a first player selecting any available playing position on one of the polygonal fields; (b) changing display characteristics of the playing position corresponding to the selection instructions from (a) to represent a first player marker; (c) receiving rotation instructions indicative of the first player selecting one of the polygonal fields for rotation, and indicative of direction of rotation; (d) updating and displaying the overall playing field rendering in accordance with the rotation instructions; (e) thereafter, receiving selection instructions indicative of a second player selecting any available playing position on one of the polygonal fields; (f) changing display characteristics of the playing position corresponding to the selection instructions from (e) to represent a second player marker; (g) receiving additional rotation instructions indicative of the second player selecting one of the polygonal fields for rotation, and indicative of direction of rotation; (h) updating and displaying the overall playing field rendering in accordance with the additional rotation instructions; and (i) repeating (a) through (h) as necessary until either n-in-a-row of first player markers results, n-in-a-row of second player markers results, or first player markers and second player markers occupy all playing positions. In this context, n is an integer greater than two.

The above and other aspects of the invention may also be carried out by a video game apparatus that performs the methods described herein. In practical embodiments, the video game apparatus may be realized as a portable mobile device, such as a personal digital assistant, a wireless phone, a digital music player, a handheld computer, a handheld video game console, or the like.

### BRIEF DESCRIPTION OF THE DRAWINGS

A more complete understanding of the present invention may be derived by referring to the detailed description and claims when considered in conjunction with the following figures, wherein like reference numbers refer to similar elements throughout the figures.

FIG. 1 is a front plan view of a wireless telephone configured in accordance with an example embodiment of the invention;

FIG. 2 is a schematic representation of a video game apparatus configured in accordance with an example embodiment of the invention;

FIG. 3 is a perspective view of an example physical board game assembly that can be used to demonstrate the video game playing methodology described herein;

FIG. 4 is a flow chart of a video game playing process, which may be performed by a video game apparatus configured in accordance with an example embodiment of the invention;

FIGS. 5-10 are example screen shots of an overall playing field at different stages during an example game between two players;

FIG. 11 is a diagram that illustrates a simple encoding scheme for identifying fields for the video game;

FIG. 12 is a diagram that illustrates a simple encoding scheme for identifying playing positions on a field for the video game;

FIG. 13 is a diagram that illustrates a simple encoding scheme for identifying rotation directions on a field for the video game;

FIG. 14 is a diagram that illustrates an example touchscreen input for identifying a rotation direction on a field for the video game;

FIG. 15 is an example screen shot with an alternate winning pattern depicted;

FIG. 16 is an example screen shot with an alternate winning pattern depicted;

FIG. 17 is an example screen shot of an overall playing field for a video game configured in accordance with an alternate embodiment of the invention;

FIG. 18 is an example screen shot of an overall playing field for a video game configured in accordance with another alternate embodiment of the invention; and

FIG. 19 is a diagram of a square-shaped field suitable for use with a video game configured in accordance with an alternate embodiment of the invention.

### DETAILED DESCRIPTION

The following detailed description is merely illustrative in nature and is not intended to limit the invention or the application and uses of the invention. Furthermore, there is no intention to be bound by any expressed or implied theory presented in the preceding technical field, background, brief summary or the following detailed description.

The invention may be described herein in terms of functional and/or logical block components and various processing steps. It should be appreciated that such block components may be realized by any number of hardware, software, and/or firmware components configured to perform the specified functions. For example, an embodiment of the invention may employ various integrated circuit components, e.g., memory elements, digital signal processing elements, video processing elements, logic elements, look-up tables, or the like, which may carry out a variety of functions under the control of one or more microprocessors or other control devices. In addition, those skilled in the art will appreciate that the present invention may be practiced in conjunction with any number of video game platforms and that the example devices described herein are merely exemplary applications for the invention.

For the sake of brevity, conventional techniques related to video and graphics signal processing, graphics rendering, user interfaces, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in a practical embodiment.

The following description may refer to elements or features being “connected” or “coupled” together. As used herein, unless expressly stated otherwise, “connected” means that one element/feature is directly joined to (or directly communicates with) another element/feature, and not necessarily mechanically. Likewise, unless expressly stated otherwise, “coupled” means that one element/feature is directly or indirectly joined to (or directly or indirectly communicates with) another element/feature, and not necessarily mechanically. Thus, although the schematic shown in FIG. 2 depicts one example arrangement of elements, additional intervening elements, devices, features, or components may be present in an actual embodiment (assuming that the functionality of the device is not adversely affected).

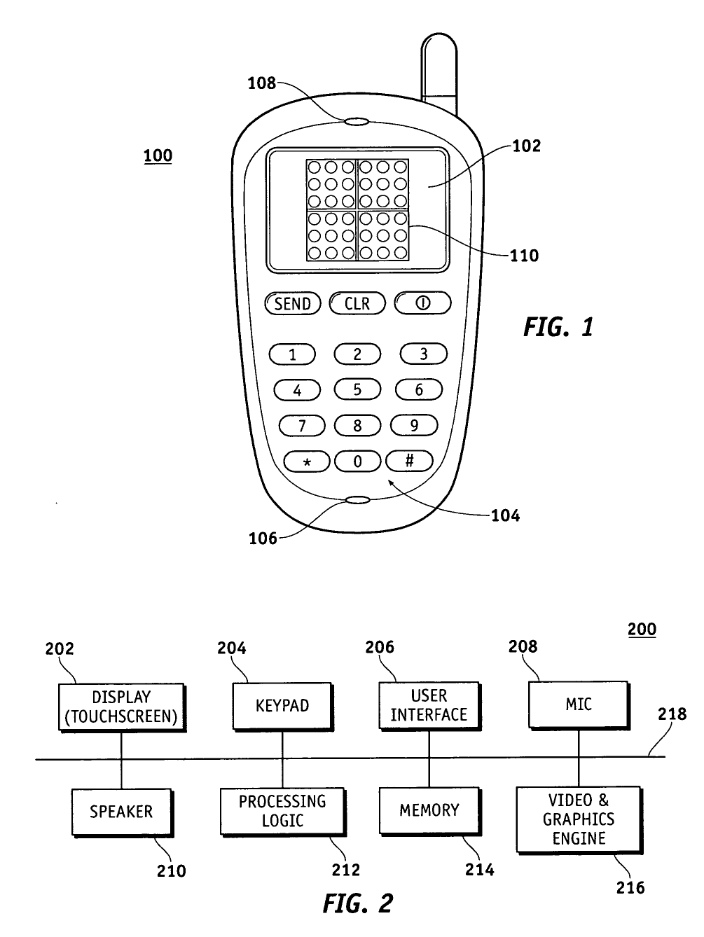

FIG. 1 is a front plan view of a wireless telephone 100 configured in accordance with an example embodiment of the invention. Wireless telephone 100 represents merely one example deployment of a video game apparatus according to the invention. Indeed, those skilled in the art will recognize that the video game apparatus and game playing methodologies described herein can be equivalently ported to any suitable video game platform, computing device, computer network, or the like. In this regard, the video game described herein may also be deployed in any of the following devices, without limitation: personal digital assistants; pagers; digital music players; handheld, laptop, desktop, networked, and other computers; video game consoles; portable handheld video games; remote control devices; and any computing device or platform having sufficient hardware, firmware, and/or software capabilities. Moreover, the video game described herein may be implemented with a single device or a plurality of devices (e.g., for multi-player games) that are configured to communicate with each other via any suitable technique (e.g., wireless communication, a cable connection, a network connection, via the Internet, via a wireless telecommunication service provider network, or the like). For the sake of simplicity and brevity, the following description relates to a two-player game implemented on wireless telephone 100. Of course, one of the players may be a “virtual” player such that one human player can enjoy the video game at his or her leisure. In addition, both of the players may be virtual players, which may be desirable for purposes of a demonstration mode on the host computing platform.

As depicted in FIG. 1, wireless telephone 100 generally includes a display element 102, an alphanumeric keypad 104, a microphone port 106, and a speaker port 108. All of these elements operate in accordance with well-established technologies and, therefore, these elements will not be described in detail herein. Display element 102 is utilized to display video and/or graphical images rendered by the video game logic described in more detail below. In preferred embodiments, display element 102 supports color graphics at a desired resolution that provides an enjoyable game playing experience to the user(s). FIG. 1 depicts an overall playing field rendering 110 generated on display element 102. The overall playing field is described in detail below.

Microphone port 106 may be utilized to receive voice commands from one or both players, where such voice commands can be processed in lieu of other forms of user input such as keypad entries, touchscreen entries, or the like. That said, the example embodiment described below contemplates keypad entries for all user inputs. Speaker port 108 may be utilized to generate audible prompts, confirmation tones, or other audio effects during game play. The types of sounds, the manner in which they are generated, sound processing, and the control of sound generation may vary from application to application depending upon the desired game playing experience.

FIG. 2 is a schematic representation of a video game apparatus 200 configured in accordance with an example embodiment of the invention. Video game apparatus 200 generally includes, without limitation: a display element 202, a keypad 204, a user interface 206 (which may be optional in view of keypad 204), a microphone 208, a speaker 210, processing logic 212, an appropriate amount of memory 214, and a video/graphics engine 216. These elements may be coupled together via a suitable data communication bus 218 or any suitable interconnection architecture. Those of skill in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software depends upon the particular application and design constraints imposed on the overall system. Those familiar with the concepts described herein may implement such functionality in a suitable manner for each particular application, but such implementation decisions should not be interpreted as causing a departure from the scope of the present invention.

As mentioned above in connection with wireless telephone 100, display element 202 is suitably configured to generate video and/or graphics images as necessary to support the operation of the video game described herein. In practical embodiments, display element 202 may also incorporate a touchscreen that responds to physical manipulation of the surface of display element 202. In this regard, a touchscreen may respond to finger touches or other physical contact by a user. A touchscreen may alternatively or additionally be configured to respond to physical contact by a stylus or other “writing” instrument. In such embodiments, video game apparatus 200 includes suitable touchscreen processing logic that can interpret user entries via display element 202.

As mentioned above in connection with wireless telephone 100, keypad 204 allows the user(s) to enter alphanumeric data into video game apparatus 200. Although not shown in FIG. 2 (or in FIG. 1), each key of keypad 204 may have alternate or “shift” designators as is well known in the art. For example, the key for number “2” is also traditionally associated with the letters A, B, and C. In the example video game embodiment described herein, keypad 204 is utilized to generate alphanumeric sequences that control game playing operations and player selections. Alternate embodiments may employ one or more additional user interface 206 features, such as a touchpad, a joystick, a mouse, a trackball, a voice command processor, Braille buttons, a vibrating device, tactile feedback elements, lights, or the like. User interface 206 can be specifically configured to suit the needs of the particular application. Video game apparatus 200 may also include one or more microphones 208 and one or more speakers 210, which enable voice command processing (an optional means of obtaining user instructions) and audio feedback for enhancing the game playing experience.

Processing logic 212 may be implemented or performed with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this regard, a processor may be realized as a microprocessor, a controller, a microcontroller, or a state machine. A processor may also be implemented as a combination of computing devices, e.g., a combination of a digital signal processor and a microprocessor, a plurality of microprocessors, one or more microprocessors in conjunction with a digital signal processor core, or any other such configuration. In practice, processing logic 212 is suitably configured to control video/graphics engine 216 to generate the video images and graphics needed to support the game playing operation.

Furthermore, the steps of a method or algorithm described in connection with the embodiments disclosed herein may be embodied directly in hardware, in firmware, in a software module executed by processing logic 212, or in any practical combination thereof. A software module may reside in memory 214, which may be realized as RAM memory, flash memory, ROM memory, EPROM memory, EEPROM memory, registers, a hard disk, a removable disk, a CD-ROM, or any other form of storage medium known in the art. In this regard, memory 214 can be coupled to processing logic 212 such that processing logic 212 can read information from, and write information to, memory 214. In the alternative, memory 214 may be integral to processing logic 212. As an example, processing logic 212 and memory 214 may reside in an ASIC.

Video/graphics engine 216 (which may be incorporated in processing logic 212) is suitably configured to process video and/or graphics information for the video game, and to format the video and/or graphics information for rendering on display element 202. The particular configuration and operation of video/graphics engine 216 may vary to suit the needs of the given video game platform. Video/graphics engines are generally known to those skilled in the video game, video processing, and graphics fields and, for the sake of brevity, such known aspects will not be described herein.

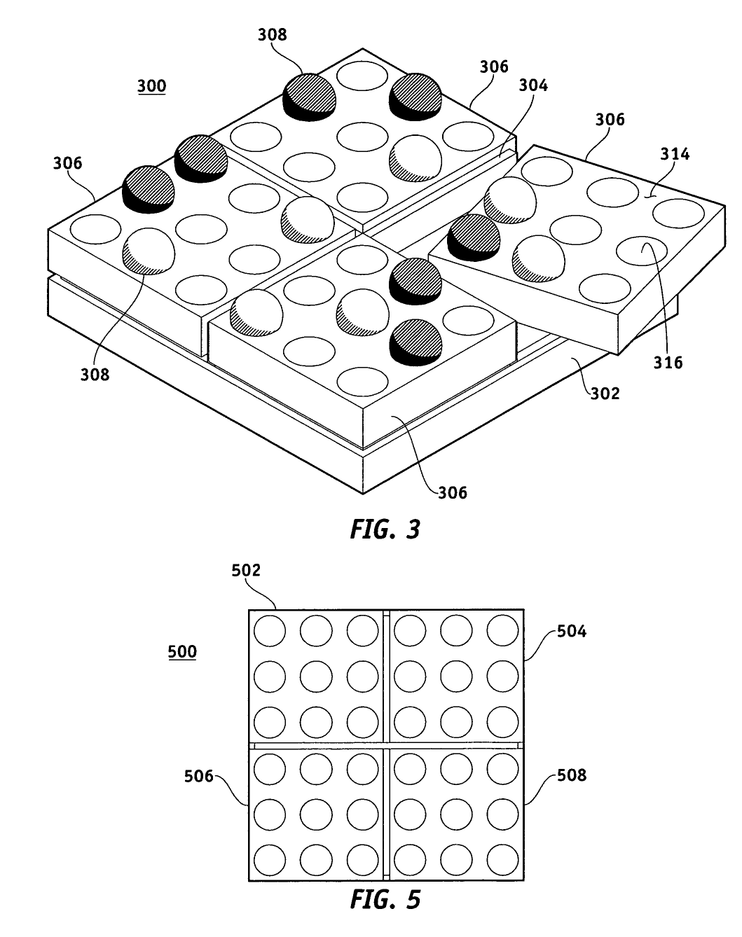

Video game apparatus 200 supports a virtual strategic board game between two players (where one or both players may be computer-generated). FIG. 3 is a perspective view of an example physical board game assembly 300 that can be used to demonstrate the video game playing methodology described herein. Board game assembly 300 generally includes a base 302, a dividing wall structure 304 coupled to base 302, a number (N) of polygonal blocks 306, and suitably colored, marked, shaped, or otherwise distinguishable playing pieces 308. FIG. 3 depicts example playing pieces and one block shifted from its normal orientation.

Base 302 includes a support surface that is configured to support polygonal blocks 306 during play. Dividing wall structure 304 extends from the support surface such that it divides the support surface into a number (N) of retaining areas. In this example, dividing wall structure 304 is orthogonal to the support surface, and dividing wall structure 304 extends to a height that is slightly below the playing surface 314 of polygonal blocks 306. The height of dividing wall structure 304 relative to polygonal blocks 306 makes it easy for the players to grasp, remove, and replace polygonal blocks 306 as described in more detail herein. The height of dividing wall structure 304 relative to polygonal blocks 306 also creates a pleasing aesthetic appearance for board game assembly 300.

Each polygonal block 306 is shaped to fit within the retaining areas. In the practical embodiment, each polygonal block 306 is substantially identical, and each polygonal block 306 is configured to mate with the upper surface of base 302 and the respective sidewalls of dividing wall structure 304. The close fit between polygonal blocks 306, base 302, and dividing wall structure 304 results in a clean and symmetrical appearance for board game assembly 300. Moreover, when properly placed in the retaining areas, polygonal blocks 306 become adjacent to one another and combine to form an overall playing field for board game assembly 300.

Each polygonal block 306 has a playing surface 314 that is configured to receive up to a designated number (M) of playing pieces 308. In the illustrated embodiment, each playing surface 314 includes M holders 316 configured to hold playing pieces 308. In practice, each holder 316 may be realized as a depression formed in base 302. In alternate embodiments, each holder 316 may be realized as any suitable feature, component, or element that serves to temporarily secure, retain, support, or hold a playing piece 308 in the designated location on polygonal block 306. In other embodiments, playing surface 314 may simply be patterned with indicia of the desired locations for playing pieces 308.

As shown in FIG. 3, each polygonal block 306 is removable from its respective retaining area (in alternate embodiments, at least one polygonal block 306 may be attached, in a fixed position, to the support surface and/or to dividing wall structure 304). In the example embodiment, each polygonal block 306 is loose and completely free to move relative to base 302. In other words, polygonal blocks 306 need not be attached, secured, adhered to, or otherwise maintained on the support surface. The removable nature of polygonal blocks 306 facilitates game play, i.e., the players can easily remove, rotate, and replace polygonal blocks 306 in the manner dictated by the game rules. Notably, each polygonal block 306 has rotational symmetry about an axis orthogonal to playing surface 314. As used herein, “rotational symmetry” means that the polygonal block 306 can be rotated a certain amount while maintaining the topology and layout orientation of its holders 316. In practice, the amount of rotation needed to achieve such symmetry will depend upon the particular shape of polygonal blocks 306.

Generally, each polygonal block 306 has a number (S) of equal-length sides, and each side corresponds to a like number of playing pieces 308. In this regard, the example embodiment utilizes square blocks having four equal-length sides, and each side corresponds to three playing pieces 308. In other words, each side accommodates up to three playing pieces 308. In preferred embodiments, each polygonal block 306 is square shaped, and the playing surface 314 of each polygonal block 306 represents an m-by-m grid for playing pieces 308, where m=\sqrt{M}. The rotational symmetry of a square block can be easily conceptualized: each square block can be removed from its respective retaining area, rotated 90 degrees, 180 degrees, or 270 degrees clockwise or counterclockwise and replaced into its respective retaining area. In this example embodiment, N=4 (i.e., there are four polygonal blocks 306 and four retaining areas), M=9 (i.e., each polygonal block 306 can hold up to nine playing pieces 308), and m=3 (i.e., each polygonal block 306 represents a three-by-three grid for playing pieces 308.

The example embodiment shown in FIG. 3 is suitable for two-player use. Accordingly, playing pieces 308 include a plurality of first playing pieces (for one of the players) and a plurality of second playing pieces (for the other player), where the two groups of playing pieces are distinguishable from one another. For example, one group of playing pieces 308 may be realized as black marbles, and the other group of playing pieces 308 may be realized as white marbles. Alternatively, different sizes, shapes, textures, and/or other distinguishing characteristics may be employed to ensure that the different playing pieces 308 can be easily assigned to the players. Furthermore, more than two different types of playing pieces 308 can be employed as necessary for more than two players.

Board game assembly 300 is suitably configured to facilitate game play by two players. Briefly, the object of the game is to establish a pattern of five-in-a-row before your opponent does the same. The playing rules are very simple and easy to learn: the first player places one of his playing pieces into an available holder, then rotates a square block to complete his turn. The players alternate in this manner until one of them creates five-in-a-row. A two-player game will be described in more detail with reference to the remaining figures, where one player uses dark colored markers and the other player uses light colored markers. Of course, actual game play, strategies, and player moves will vary due to the dynamic nature of the game, and may vary depending upon the particular configuration of the board game assembly in use (e.g., the number of polygonal blocks, the number of holders on each polygonal block, the shape of each polygonal block, etc.).

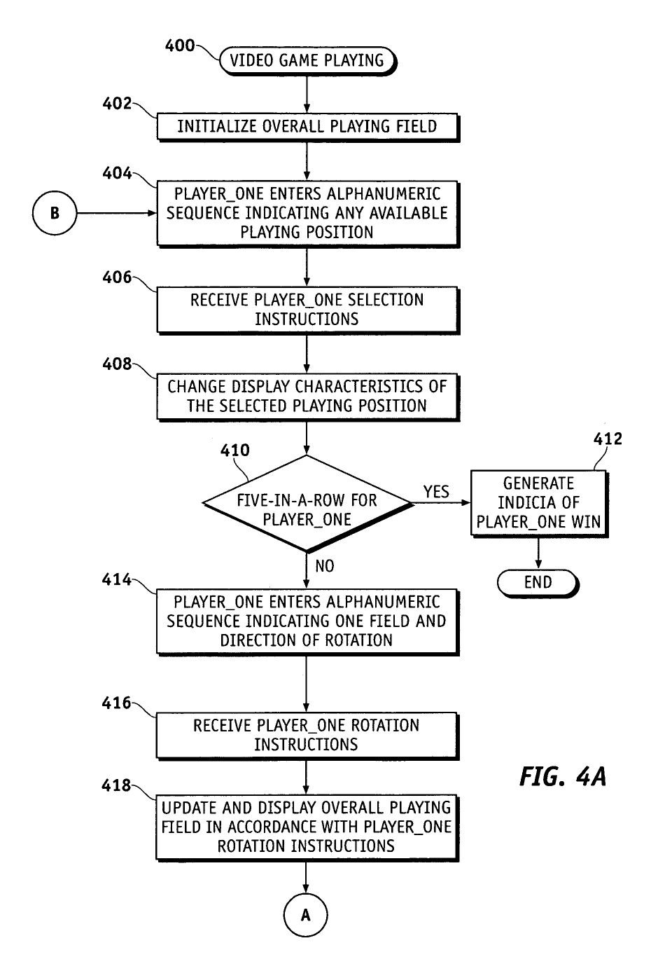

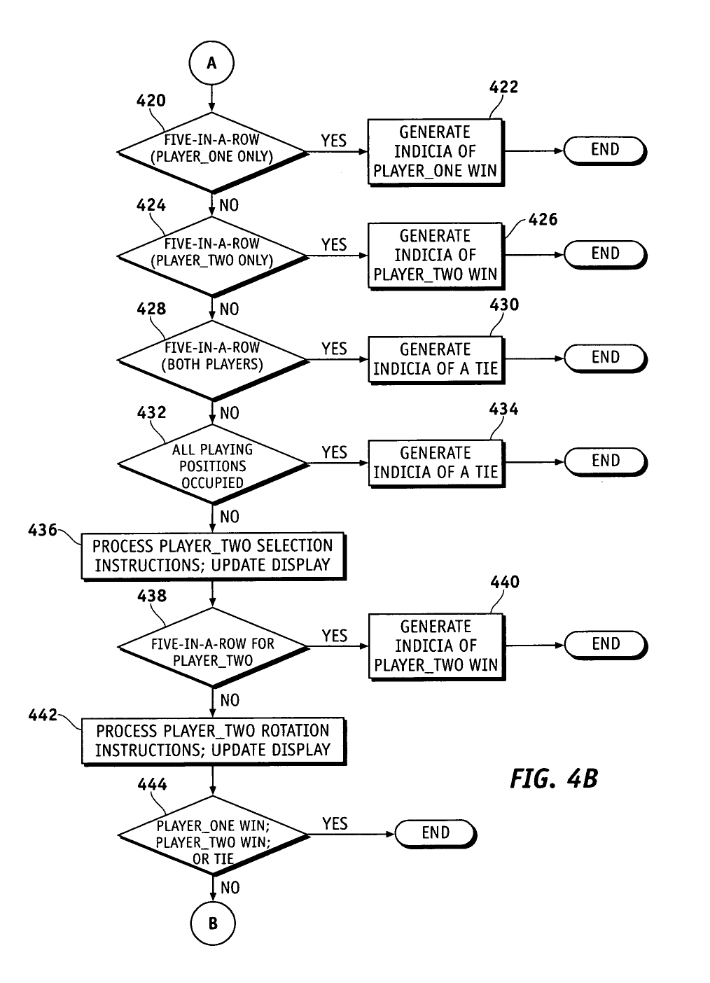

The game playing methodology of board game assembly 300 can be performed by video game apparatus 200 in any suitable manner. For example, FIG. 4 is a flow chart of a video game playing process 400, which may be performed by a video game apparatus configured in accordance with an example embodiment of the invention. The various tasks performed in connection with process 400 may be performed by software, hardware, firmware, or any combination thereof. For illustrative purposes, the following description of process 400 may refer to elements mentioned above in connection with FIG. 1 and FIG. 2. In practical embodiments, portions of process 400 may be performed by different elements of the described system, e.g., display element 202, processing logic 212, or video/graphics engine 216 (see FIG. 2). It should be appreciated that process 400 may include any number of additional or alternative tasks, the tasks shown in FIG. 4 need not be performed in the illustrated order, and process 400 may be incorporated into a more comprehensive procedure or process having additional functionality not described in detail herein.

Video game playing process 400 begins by initializing the overall playing field (task 402). In other words, the game begins with an empty overall playing field 500, as shown in FIG. 5. FIG. 5 illustrates the manner in which four square-shaped fields (502, 504, 506, and 508) are positioned adjacent to one another to form overall playing field 500 (a nine-by-nine grid of playing positions) for the video game. The two players determine who will move first using any suitable technique (or process 400 makes the determination), then the first player (“player_one”) provides selection instructions indicative of a selection of any available playing position on one of the square-shaped fields. In this example embodiment, the first player enters an appropriate alphanumeric sequence to indicate the selected playing position (task 404).

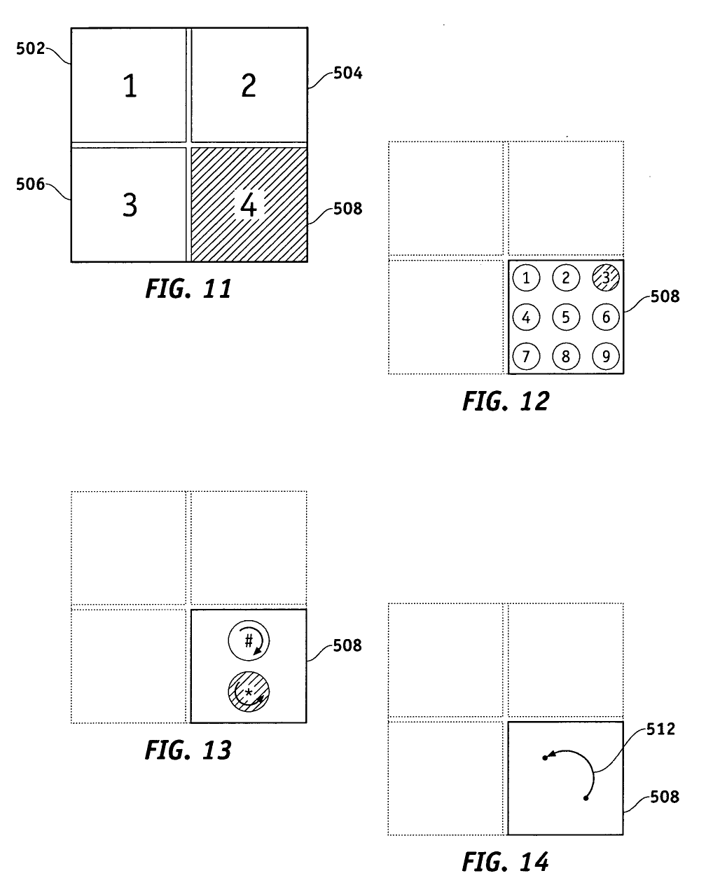

In a practical deployment that utilizes a keypad for data entry, the alphanumeric sequence in task 404 may be carried out in the following manner. FIG. 11 is a diagram that illustrates a simple encoding scheme for identifying fields for the video game, and FIG. 12 is a diagram that illustrates a simple encoding scheme for identifying playing positions on a field for the video game. As depicted in FIG. 11, each square-shaped field is assigned a unique field identifier (which may be an alphanumeric character such as a number) that can be selected via a keypad. In this example, the number “1” indicates field 502, the number “2” indicates field 504, the number “3” indicates field 506, and the number “4” indicates field 508. Thus, the first player can select one of the four square fields by simply entering one of these numbers on the keypad. In this example, the first player has selected field 508 by entering the number “4” on the keypad. Although not required, video game playing process 400 may display the encoding scheme shown in FIG. 11 and/or temporarily superimpose the encoding scheme shown in FIG. 11 over the display of overall playing field 500 to prompt the selection by the first player.

In addition to the selection of a field, the first player must select an available or open playing position on the selected field. As depicted in FIG. 12, each playing position on a field may be assigned a unique grid point identifier (which may be an alphanumeric character such as a number) that can be selected via a keypad. In this example, a number from “1” to “9” uniquely identifies a respective one of the nine playing positions on the field. Thus, the first player can select one of the nine playing positions by simply entering one of the numbers “1” to “9” on the keypad. In this example, the first player has selected the upper right playing position by entering the number “3” on the keypad. Although not required, video game playing process 400 may display the encoding scheme shown in FIG. 12 and/or temporarily superimpose the encoding scheme shown in FIG. 12 over the display of overall playing field 500 to prompt the selection by the first player. As a shortcut technique, the first player may quickly enter the sequence “4-3” (or an equivalent sequence “3-4”) to identify the desired field and playing position in a single step. Of course, alternate encoding schemes may be utilized in an actual implementation of the video game. In addition, a touchscreen version of the video game apparatus may accommodate direct user selection of the desired playing position. For example, process 400 may display the current state of overall playing field 500 and respond to a touchscreen input for a displayed location of any available playing position. In other words, the first player can directly enter the selected playing position via physical contact with the corresponding area on the surface of the display element, and the selection instructions are derived from the touchscreen input.

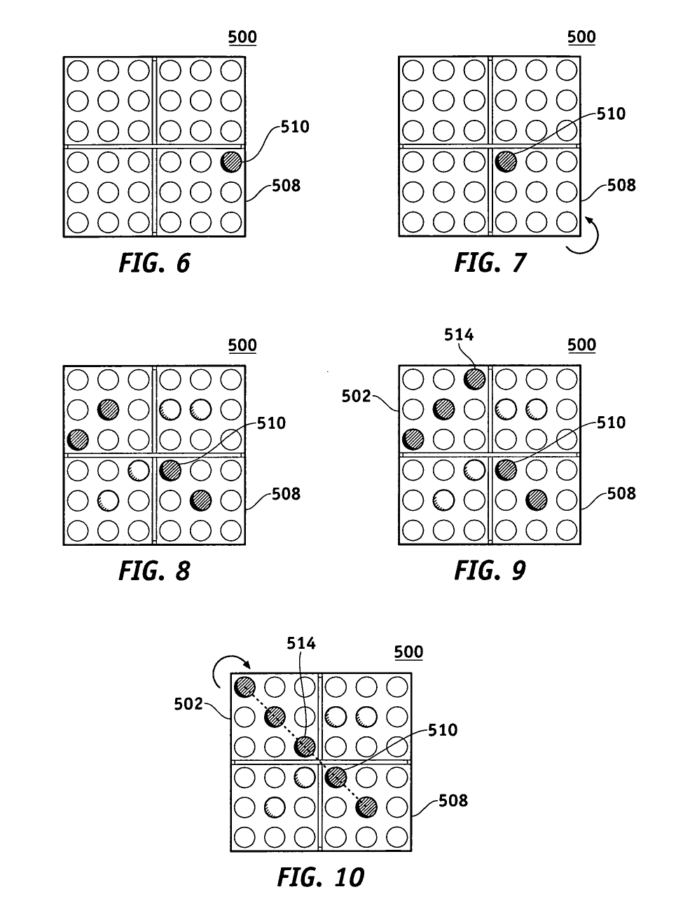

Referring again to FIG. 4, video game playing process 400 receives selection instructions indicative of the first player's selection (task 406) and processes the instructions in an appropriate manner. In particular, process 400 changes the display characteristics of the selected playing position to represent a first player marker at that position (task 408). In practice, the first player markers may be a first color, pattern, shade, size, or shape, and the second player markers may be a second color, pattern, shade, size, or shape (in this example, the first player has dark colored markers and the second player has light colored makers). FIG. 6 depicts the display of overall playing field 500 with a rendering of a dark first player marker 510 at the selected playing position on field 508. In the example embodiment, once a marker is positioned, it remains in that grid “location” on its field for the duration of the game (note that this fixed location can rotate within the square-shaped field during game play, as described below).

At this point, video game playing process 400 may check to determine whether the current state of the overall playing field corresponds to a “win” by the first player. Depending upon the state of the game, this check may be bypassed. For example, at early game stages where it is impossible to have a win or a tie, process 400 may simply proceed to the task 414 described below. Assuming this check is performed, process 400 may perform a query task 410 to determine whether five-in-a-row of first player markers has resulted from the first player's “placement” of a marker. If so, then process 400 may generate indicia of a first player win (task 412). Such indicia may take any suitable form, such as a displayed message, flashing lights, audio feedback, or the like.

If, however, query task 410 determines that five-in-a-row of first player markers has not occurred, then the first player provides rotation instructions indicative of a selection of one of the square-shaped fields. The rotation instructions may also be indicative of a direction of rotation for the selected field. In this example embodiment, the first player enters an appropriate alphanumeric sequence to indicate the selected field and direction of rotation (task 414). In a practical deployment that utilizes a keypad for data entry, the alphanumeric sequence in task 414 may be carried out in the following manner. The first player may initially select a square-shaped field in the manner described above in connection with FIG. 11. In accordance with the game rules, the first player is free to select any of the four fields for rotation. In this example, the first player selects field 508 for rotation by entering the number “4” on the keypad.

In addition to the selection of a field, the first player must select an direction of rotation (clockwise or counterclockwise) for the selected field. In practice, the rotation direction may be selected using alphanumeric characters on the keypad, where clockwise rotation corresponds to one rotation direction identifier and counterclockwise rotation corresponds to another rotation direction identifier. For example, as depicted in FIG. 13, clockwise rotation of the selected field may be associated with the “*” button, while counterclockwise rotation of the selected field may be associated with the “#” button. Thus, the first player can simply chose the desired rotation direction via the keypad. In this example, the first player has selected counterclockwise rotation of field 508 by pressing the “#” button on the keypad. Although not required, video game playing process 400 may display the screen shown in FIG. 13 and/or temporarily superimpose the screen shown in FIG. 13 over the display of overall playing field 500 to prompt the rotation selection by the first player. As a shortcut technique, the first player may quickly enter the sequence “4-#” (or an equivalent sequence “#-4”) to identify the desired field 508 and counterclockwise rotation of field 508 in a single step. Of course, alternate encoding schemes may be utilized in an actual implementation of the video game. In addition, a touchscreen version of the video game apparatus may accommodate direct user selection of the desired field and direct user selection of the rotation direction. For example, process 400 may display the current state of overall playing field 500 and respond to a touchscreen input that controls rotation of a selected square-shaped field. FIG. 14 is a diagram of an example touchscreen input that may be utilized in such an embodiment. FIG. 14 depicts a traced counterclockwise curve 512 corresponding to counterclockwise rotation for field 508. Video game playing process 400 may leverage existing stylus writing processes to accommodate such touchscreen inputs. In this manner, the first player can directly and quickly control the rotation of the selected field 508, where the rotation instructions are derived from the touchscreen input.

Referring again to FIG. 4, video game playing process 400 receives rotation instructions indicative of the first player's selection of a field, rotation instructions indicative of the first player's chosen rotation direction (task 416), and proceeds to process the instructions in an appropriate manner. In particular, process 400 updates and displays the overall playing field 500 in accordance with the first player's rotation instructions (task 418). In other words, process 400 renders the overall playing field 500 after rotation of the selected field. According to the game rules in this example embodiment, field rotation must be either 90 degrees clockwise or 90 degrees counterclockwise relative to its original orientation. In this regard, FIG. 7 depicts the counterclockwise rotation of field 508. Notably, rotation of field 508 results in movement of player marker 510 on the overall playing field 500.

During the early stages of the game, a player may choose to rotate an empty square-shaped field or a square-shaped field having a pattern of markers that is “immune” to any 90 degree rotation. For example, rotation of a field having only one marker that is located in the center of the grid will not result in any change of the overall playing field pattern. In such situations, the player may either rotate an immune field or video game playing process 400 may allow the player to simply bypass the rotation selection procedure. Eventually, enough markers will occupy all of the fields such that no immune fields remain.

At this point, video game playing process 400 may check to determine whether the current state of the overall playing field corresponds to a “win” by the first player, a “win” by the second player, or a tie. As mentioned previously, depending upon the state of the game, this check may be bypassed and process flow may skip to task 436. Assuming these checks are performed, process 400 may perform a query task 420 to determine whether five-in-a-row of first player markers has occurred in the absence of five-in-a-row of second player markers. If so, then process 400 may generate indicia of a first player win (task 422). Such indicia may take any suitable form, such as a displayed message, flashing lights, audio feedback, or the like. A negative response to query task 420 leads to a query task 424, which determines whether five-in-a-row of second player markers has occurred in the absence of five-in-a-row of first player markers. If so, then process 400 may generate indicia of a second player win (task 426). Such indicia may take any suitable form, such as a displayed message, flashing lights, audio feedback, or the like. A negative response to query task 424 leads to a query task 428, which determines whether five-in-a-row of first player markers and five-in-a-row of second player markers has occurred at the same time. If so, then process 400 may generate indicia of a tie (task 430). Such indicia may take any suitable form, such as a displayed message, flashing lights, audio feedback, or the like. A negative response to query task 428 leads to a query task 432, which determines whether all of the playing positions are occupied. If all of the playing positions are now occupied by player markers, then process 400 may generate indicia of a tie (task 434). Such indicia may take any suitable form, such as a displayed message, flashing lights, audio feedback, or the like. If query task 432 determines that at least one of the playing positions remains unoccupied, then process 400 proceeds to enable the second player to enter a move.

The first player's turn is complete after video game playing process 400 rotates one of the square-shaped fields. Thereafter, the second player (“player_two”) controls his turn as described above for the first player. Briefly, process 400 will receive and suitably process the second player's selection instructions and update the display of the overall playing field as needed (task 436). In this regard, the second player may enter an alphanumeric sequence to cause process 400 to indicate a second player marker at a formerly available playing position. At this point, process 400 may check to determine whether the current state of the overall playing field corresponds to a “win” by the second player. Again, at early game stages where it is impossible to have a win or a tie, process 400 may bypass this check and proceed to task 442 described below. Assuming this check is performed, process 400 may perform a query task 438 to determine whether five-in-a-row of second player markers has resulted from the second player's “placement” of a marker. If so, then process 400 may generate indicia of a second player win (task 440). Such indicia may take any suitable form, such as a displayed message, flashing lights, audio feedback, or the like.

If, however, query task 438 determines that five-in-a-row of second player markers has not occurred, then game playing process 400 will receive and suitably process the second player's rotation instructions and update the display of the overall playing field as needed (task 442). In this regard the second player provides rotation instructions indicative of a selection of one of the square-shaped fields and the rotation instructions are processed in the manner described above for the first player's turn. After video game playing process 400 has rotated the second player's selected field, process 400 can again check for a first player win, a second player win, or a tie (query task 444) in the manner described above in connection with tasks 420-434. If a win or a tie results, process 400 will generate appropriate indicia as mentioned above. If query task 444 determines that play is to continue, then process 400 can be re-entered at task 404. The players alternate turns in this manner until either five-in-a-row of first player markers results, five-in-a-row of second player markers results, or markers occupy all of the grid points. Since five-in-a-row is the objective of this version of the video game, the first player is declared a winner when five-in-a-row of his markers occurs before five-in-a-row of the second player markers. In contrast, the second player is declared a winner when five-in-a-row of his markers occurs before five-in-a-row of the first player markers. In alternate embodiments having different overall playing surface layouts, the object of the game will be to establish n-in-a-row of the same player markers, where n is any integer greater than two.

FIGS. 8-10 depict a winning move sequence that results in a win by the first player. FIG. 8 shows the overall playing field 500 after the second player has completed his turn. FIG. 9 shows the overall playing field 500 layout following the first player's “placement” of a dark player marker 514 at a grid point on the upper left field 502. FIG. 10 shows the overall playing field 500 layout following rotation of field 502 by 90 degrees in the clockwise direction. Rotation of field 502 in this manner results in a win by the first player because the overall playing field 500 now includes a pattern of five dark player markers in a row (identified by the dashed line in FIG. 10).

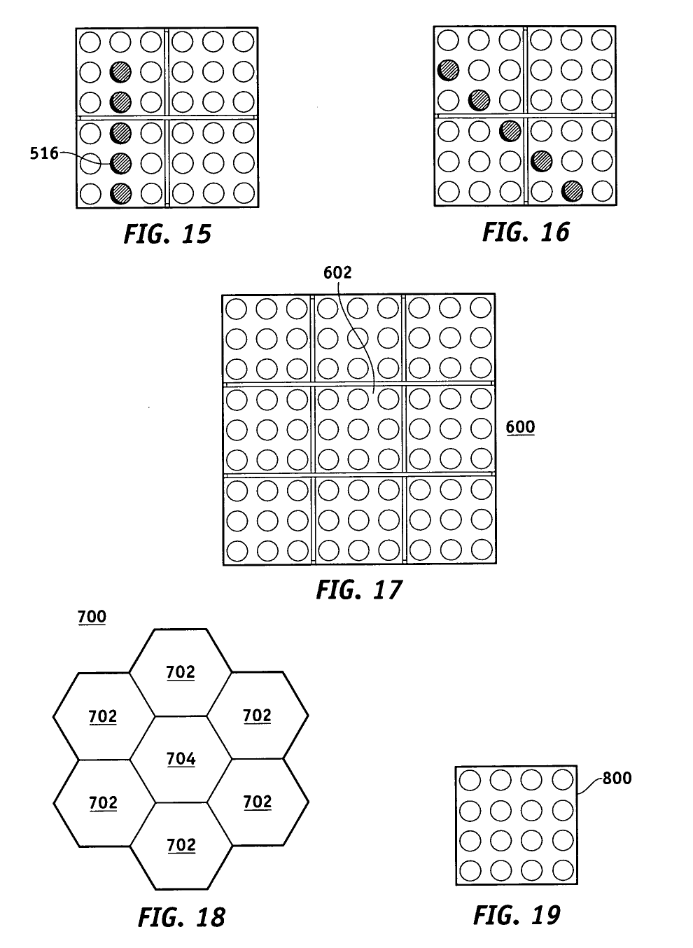

FIG. 15 and FIG. 16 depict other winning patterns that may be achieved during game play. Using the example overall playing field layout described above, a winning pattern of five-in-a-row will span at least two, and possibly three, square-shaped fields. A winning pattern may be horizontal, vertical, or diagonal. As described above in connection with FIGS. 8-10, a winner is declared when the rotation of a field results in five-in-a-row for that player. According to the rules of this particular game, a winner is also declared when the mere “placement” of a marker results in five-in-a-row for that player. For example, assume that the dark marker 516 in FIG. 15 has not yet been displayed, and that the respective playing position was left unoccupied at the completion of the previous turn by the second player. The first player is declared a winner once he “places” his marker 516 into the position shown in FIG. 15. In other words, the first player need not rotate a field in this situation.

A game may also result in a tie according to the rules of the example game described herein. In this regard, a tie is declared when markers occupy all of the grid positions and neither player has made five-in-a-row. This may occur when both players are defensive-minded. Moreover, a tie may be declared when rotation of one of the square-shaped fields creates five-in-a-row of the dark markers and five-in-a-row of the light markers, as explained above.

As mentioned previously, the topology and layout of the overall playing field and/or the individual fields of the video game need not be configured as shown in FIG. 5. For example, FIG. 17 is a screen shot of an overall playing field 600 for a video game configured in accordance with an alternate embodiment of the invention. Overall playing field 600 includes nine, rather than four, square-shaped fields. This configuration may be suitable for use with more than two players and/or for use with advanced games that require more than five-in-a-row to win. In one practical embodiment, at least one square-shaped field of overall playing field 600 is in a fixed position, i.e., it cannot be rotated. For example, a center field 602 may be fixed while all remaining fields are free to rotate as described above.

FIG. 18 is an example screen shot of an overall playing field 700 for a video game configured in accordance with another alternate embodiment of the invention. Overall playing field 700 includes hexagonal fields 702 rather than square fields. A hexagonal center field 704 may, but need not be, fixed to prevent rotation thereof. Although not shown in FIG. 18, fields 702 and field 704 preferably have an identical layout of grid points for a like number of playing markers.

FIG. 19 is a diagram of a square-shaped field 800 suitable for use with a video game configured in accordance with an alternate embodiment of the invention. Field 800 includes a four-by-four grid of 16 playing positions rather than a three-by-three grid of nine playing positions. As described above, a video game according to the invention may use any number of fields 800 to form the overall playing field. A simple example embodiment may utilize four fields 800 arranged to form an overall square layout (an eight-by-eight grid of playing positions).

In summary, a video game and game playing method according to the invention is simple and stylistic, yet very intelligent and deep with strategy and logic. The dynamic nature of the playing field makes the game challenging and interesting for all skill levels.

While at least one example embodiment has been presented in the foregoing detailed description, it should be appreciated that a vast number of variations exist. It should also be appreciated that the example embodiment or embodiments described herein are not intended to limit the scope, applicability, or configuration of the invention in any way. Rather, the foregoing detailed description will provide those skilled in the art with a convenient road map for implementing the described embodiment or embodiments. It should be understood that various changes can be made in the function and arrangement of elements without departing from the scope of the invention as set forth in the appended claims and the legal equivalents thereof.

What is claimed is:

1. A method of operating a video game having an overall playing field rendering having a nine-by-nine grid of playing positions, said overall playing field rendering including four generally square-shaped fields, each having a three-by-three grid of playing positions, said method comprising:
(a) receiving selection instructions indicative of a first player selecting any available playing position on one of said square-shaped fields;
(b) changing display characteristics of the playing position corresponding to the selection instructions from step (a) to represent a first player marker;
(c) receiving rotation instructions indicative of said first player selecting one of said square-shaped fields for rotation, and indicative of direction of rotation;
(d) updating and displaying said overall playing field rendering in accordance with said rotation instructions;
(e) thereafter, receiving selection instructions indicative of a second player selecting any available playing position on one of said square-shaped fields;
(f) changing display characteristics of the playing position corresponding to the selection instructions from step (e) to represent a second player marker;
(g) receiving additional rotation instructions indicative of said second player selecting one of said square-shaped fields for rotation, and indicative of direction of rotation;
(h) updating and displaying said overall playing field rendering in accordance with said additional rotation instructions; and
(i) repeating steps (a) through (h) as necessary until either five-in-a-row of first player markers results, five-in-a-row of second player markers results, or first player markers and second player markers occupy all playing positions.

2. A method according to claim 1, wherein:
said step (d) updates and displays said overall playing field rendering to indicate rotation of one of said square-shaped fields 90 degrees clockwise or 90 degrees counterclockwise relative to its original orientation; and
said step (h) updates and displays said overall playing field rendering to indicate rotation of one of said square-shaped fields 90 degrees clockwise or 90 degrees counterclockwise relative to its original orientation.

3. A method according to claim 1, further comprising:
generating indicia of a first player win when any iteration of step (b) results in five-in-a-row of first player markers; and
generating indicia of a second player win when any iteration of step (f) results in five-in-a-row of second player markers.

4. A method according to claim 1, further comprising:
generating indicia of a first player win when any iteration of step (d) results in five-in-a-row of first player markers; and
generating indicia of a second player win when any iteration of step (h) results in five-in-a-row of second player markers.

5. A method according to claim 1, further comprising generating indicia of a tie when first player markers and second player markers occupy all playing positions.

6. A method according to claim 1, further comprising:
generating indicia of a tie when any iteration of step (d) results in five-in-a-row of first player markers and five-in-a-row of second player markers; and
generating indicia of a tie when any iteration of step (h) results in five-in-a-row of first player markers and five-in-a-row of second player markers.

7. A method according to claim 1, wherein said step (a) comprises:
receiving a field identifier that indicates a selected square-shaped field among said square-shaped fields; and
receiving a grid point identifier that indicates a selected playing position on said selected square-shaped field.

8. A method according to claim 7, said field identifier corresponding to a first alphanumeric entry, and said grid point identifier corresponding to a second alphanumeric entry.

9. A method according to claim 1, wherein said selection instructions in step (a) are derived from a touchscreen input for a displayed location of any available playing position on one of said square-shaped fields.

10. A method according to claim 1, wherein said step (c) comprises:
receiving a field identifier that indicates a selected square-shaped field among said square-shaped fields; and
receiving a rotation direction identifier that indicates a selected direction of rotation for said selected square-shaped field.

11. A method according to claim 10, said field identifier corresponding to a first alphanumeric entry, and said rotation direction identifier corresponding to a second alphanumeric entry.

12. A method according to claim 1, wherein said rotation instructions in step (c) are derived from a touchscreen input for a displayed location of one of said square-shaped fields.

13. A method according to claim 12, said touchscreen input comprising a traced clockwise curve corresponding to clockwise rotation for one of said square-shaped fields.

14. A method according to claim 12, said touchscreen input comprising a traced counterclockwise curve corresponding to counterclockwise rotation for one of said square-shaped fields.

15. A method of operating a video game having an overall playing field rendering having a grid of playing positions, said overall playing field rendering including a plurality of polygonal fields, each having a plurality of playing positions, said method comprising:
(a) receiving selection instructions indicative of a first player selecting any available playing position on one of said polygonal fields;
(b) changing display characteristics of the playing position corresponding to the selection instructions from step (a) to represent a first player marker;
(c) receiving rotation instructions indicative of said first player selecting one of said polygonal fields for rotation, and indicative of direction of rotation;
(d) updating and displaying said overall playing field rendering in accordance with said rotation instructions;
(e) thereafter, receiving selection instructions indicative of a second player selecting any available playing position on one of said polygonal fields;
(f) changing display characteristics of the playing position corresponding to the selection instructions from step (e) to represent a second player marker;
(g) receiving additional rotation instructions indicative of said second player selecting one of said polygonal fields for rotation, and indicative of direction of rotation;
(h) updating and displaying said overall playing field rendering in accordance with said additional rotation instructions; and
(i) repeating steps (a) through (h) as necessary until either n-in-a-row of first player markers results, n-in-a-row of second player markers results, or first player markers and second player markers occupy all playing positions, where n is an integer greater than two.

16. A method according to claim 15, wherein:
said overall playing field rendering includes a nine-by-nine grid of playing positions;
each of said polygonal fields is a generally square-shaped field having a three-by-three grid of playing positions; and
said step (i) is performed until either five-in-a-row of first player markers results, five-in-a-row of second player markers results, or first player markers and second player markers occupy all playing positions.

17. A method according to claim 15, wherein:
said step (d) updates and displays said overall playing field rendering to indicate rotation of one of said polygonal fields 90 degrees clockwise or 90 degrees counterclockwise relative to its original orientation; and
said step (h) updates and displays said overall playing field rendering to indicate rotation of one of said polygonal fields 90 degrees clockwise or 90 degrees counterclockwise relative to its original orientation.

18. A method according to claim 15, further comprising:
generating indicia of a first player win when any iteration of step (b) results in n-in-a-row of first player markers; and
generating indicia of a second player win when any iteration of step (f) results in n-in-a-row of second player markers.

19. A method according to claim 15, further comprising:
generating indicia of a first player win when any iteration of step (d) results in n-in-a-row of first player markers; and
generating indicia of a second player win when any iteration of step (h) results in n-in-a-row of second player markers.

20. A method according to claim 15, further comprising generating indicia of a tie when first player markers and second player markers occupy all playing positions.

21. A method according to claim 15, further comprising:
generating indicia of a tie when any iteration of step (d) results in n-in-a-row of first player markers and n-in-a-row of second player markers; and
generating indicia of a tie when any iteration of step (h) results in n-in-a-row of first player markers and n-in-a-row of second player markers.

22. A method according to claim 15, wherein:
said step (b) comprises rendering a first colored playing piece on the playing position corresponding to the selection instructions from step (a) to indicate said first player marker; and
said step (f) comprises rendering a second colored playing piece on the playing position corresponding to the selection instructions from step (e) to indicate said second player marker.

23. A video game apparatus comprising:
a display element;
a video/graphics engine coupled to said display element; and
processing logic coupled to said video/graphics engine, said processing logic controlling said video/graphics engine to generate, on said display element, an overall playing field rendering having a grid of playing positions, said overall playing field rendering including a plurality of polygonal fields, each having a plurality of playing positions, and said processing logic being configured to:
(a) process selection instructions indicative of a first player selecting any available playing position on one of said polygonal fields;
(b) control changing of display characteristics of the playing position corresponding to the selection instructions from step (a) to represent a first player marker;
(c) process rotation instructions indicative of said first player selecting one of said polygonal fields for rotation, and indicative of direction of rotation;
(d) control updating and displaying of said overall playing field rendering in accordance with said rotation instructions;
(e) process selection instructions indicative of a second player selecting any available playing position on one of said polygonal fields;
(f) control changing of display characteristics of the playing position corresponding to the selection instructions from step (e) to represent a second player marker;
(g) process additional rotation instructions indicative of said second player selecting one of said polygonal fields for rotation, and indicative of direction of rotation;
(h) control updating and displaying of said overall playing field rendering in accordance with said additional rotation instructions; and
(i) repeat (a) through (h) as necessary until either n-in-a-row of first player markers results, n-in-a-row of second player markers results, or first player markers and second player markers occupy all playing positions, where n is an integer greater than two.
